(19) United States
(12) Patent Application Publication
(10) Pub. No.: US 2002/0178352 A1
(43) Pub. Date: Nov. 28, 2002

(54) Firmware upgrade using address conversion

(76) Inventors: John P. Lambino, Beaverton, OR (US); John V. Lovelace, Irmo, SC (US); David I. Poisner, Folsom, CA (US); Andrew W. Martwick, Folsom, CA (US)

Correspondence Address: Timothy N. Trop, TROP, PRUNER & HU, P.C., 8554 KATY FWY, STE 100, HOUSTON, TX, 77024-1805, US

(21) Appl. No.: 09/863,103

(22) Filed: May 22, 2001

(51) Int. Cl. G06F 15/177; G06F 9/00; G06F 9/24

(52) U.S. Cl. 713/2

(57) ABSTRACT

A system and method for upgrading a boot block of a firmware program is disclosed. A copy of a replacement boot block is transferred to a firmware device, and then the execution address is changed to point to this new location. The replacement boot block is then copied over the original boot block. Once the copying is complete, the execution address is restored to the original location in the firmware program.

### BACKGROUND

This invention relates to firmware for a processor-based system, and, more particularly, to a fail-safe mechanism for performing firmware upgrades.

A processor-based system typically includes firmware for initializing the system. Firmware is a software program that is permanently or semipermanently resident in the processor-based system. Usually, the software program is “burned” into a read-only memory (ROM) or a flash memory device. The ROM or flash devices may be removable integrated circuits (ICs) that plug into a dedicated chip slot in the system board.

Although the device storing the firmware may be removable and, thus, physically replaced, more typically, the device is re-programmed in place, e.g., without physical removal. ROMs may be programmable (PROMs), erasable (EPROMs), and electrically erasable (EEPROMs), such as flash memory. Flash memory is also programmable, and may typically be programmed at a faster rate than other EEPROMs.

Like other software, the firmware itself is a valuable component of the processor-based system. Firmware is the very first code executed in the system. The firmware initializes the key hardware components. Once the system is initialized, the firmware typically loads an operating system loader program into memory. The loader program then loads the operating system.

The firmware comprises part of the identity of the processor-based system. Many computer manufacturers, for example, include a proprietary firmware that includes features and capabilities that may distinguish the processor-based system from those of other manufacturers.

In many systems, the firmware is divided up where only portions of the firmware may be upgraded. This assures that, despite interruption on the firmware upgrade, a minimum amount of firmware is available to power on the system.

Sometimes, however, the non-upgradable portion of the firmware needs upgrade as well. In such cases, more draconian measures, such as physical removal of the firmware device, may be the only way to perform such upgrades.

Thus, there is a continuing need to provide a fail-safe mechanism for upgrading the firmware.

### BRIEF DESCRIPTION OF THE DRAWINGS

FIG. 1 is a block diagram of a system according to one embodiment of the invention;

FIG. 2 is a block diagram of a firmware configuration according to one embodiment of the invention;

FIG. 3 is a diagram illustrating upgrade of the boot block according to one embodiment of the invention;

FIG. 4 is a flow diagram of the firmware upgrade of FIG. 3 according to one embodiment of the invention;

FIG. 5 is a diagram illustrating upgrade of the boot block according to a second embodiment of the invention;

FIG. 6 is a flow diagram of the firmware upgrade of FIG. 5, according to the second embodiment of the invention; and

FIG. 7 is a component layout of the system according to one embodiment of the invention.

### DETAILED DESCRIPTION

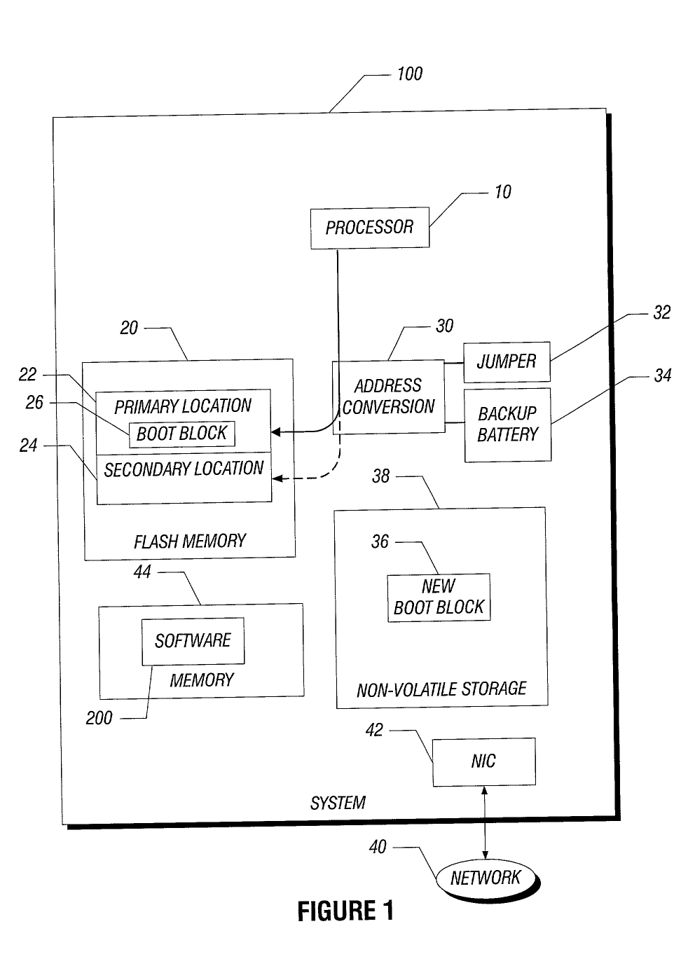

According to one embodiment, a system may successfully upgrade a boot block portion of a firmware program, as described below. In FIG. 1, a system 100 includes a processor 10 and a flash memory 20 for storing a boot block program 26. The boot block 26 is part of a firmware program, executed by the processor 10 when the system 100 powers on.

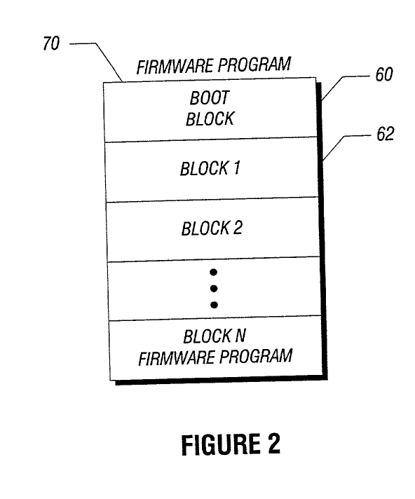

In one embodiment, the boot block 26 performs minimal initialization of the system. Typically, the boot block 26 is not upgradable. A typical firmware configuration 70 is illustrated in FIG. 2. The boot block 60, which is typically not upgradable, is followed by several upgradable blocks 62. The boot block 60 and the upgradable blocks 62 may themselves include one or more blocks (not shown).

When executed, the boot block 60 initializes the system 100 such that the other blocks 62 of the firmware program 70 may be upgraded. As will be shown below, in addition to the blocks 62 being upgradable, the boot block 60 itself may also be securely updated.

In one embodiment, the flash memory 20 includes a primary location 22 and a secondary location 24. As shown, the boot block 26 initially resides in the primary location 22. The primary location 22 and the secondary location 24 facilitate upgrade of the boot block 26, without requiring the system 100 to maintain power during the upgrade. In other words, the system 100 has a fail-safe mechanism for successfully upgrading the boot block 26, even when a power loss occurs.

In one embodiment, the system 100 further includes address conversion 30. As shown in FIG. 1, address conversion 30 enables the processor 10 to alternate between executing software located in either the primary location 22 or the secondary location 24. In one embodiment, address conversion 30 consists simply of toggling a single bit, such that a different address is accessed by the processor 10 during execution.

The address conversion 30 is coupled to a backup battery 34. In one embodiment, the backup battery 34 maintains the state of a bit that was toggled by the address conversion 30, following power off of the system 100. The backup battery 34 may be similar to those used for maintaining semi-volatile memory such as complementary metal oxide semiconductor (CMOS) memory.

In one embodiment, the system 100 further includes a jumper 32, coupled to the address conversion 30. The jumper 32 provides another mechanism for toggling the address bit, used to switch between the primary location 22 and the secondary location 24 of the flash memory 20.

The system 100 also includes a non-volatile storage 38, such as a hard disk drive. In one embodiment, the non-volatile storage 38 holds a new boot block 36. The new boot block 36 is a replacement boot block for the boot block 60 in the flash memory 20.

The new boot block 36 may be received to the system 100 from a network 40. Accordingly, the system 100 includes a network interface card (NIC) 42. The new boot block 36 may also be received from a floppy drive (not shown).

The system 100 also includes a memory 44, for storing operating system and other software, including a software program 200. In one embodiment, the software program 200 performs the steps, described below, for upgrading the boot block 60 with the new boot block 36. In other embodiments, the boot block 60 itself performs the upgrade. For simplicity, the software 200 is depicted as a separate program from the boot block 60.

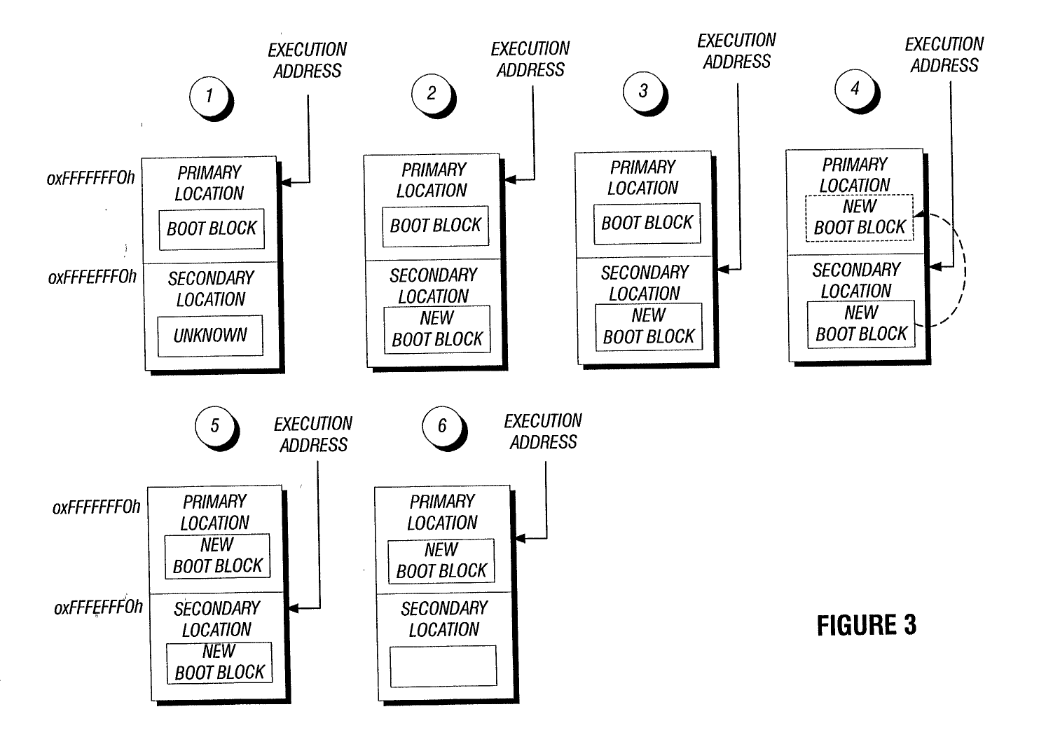

In FIG. 3, a diagram illustrates six steps or operations performed by the system 100 to upgrade the boot block 60. Each succeeding operation is specified by a numeral, 1 to 6. The primary location 22 and secondary location 24 of the flash memory 20 are shown. As in FIG. 1, the boot block 60 occupies the primary location 22. In one embodiment, the primary location is addressed at 0fffffff0h. When the system 100 receives power, execution of the firmware 70 proceeds from this address.

In one embodiment, the primary location 22 of the flash memory 20 occupies 64K of the flash memory. Accordingly, the secondary location 24, which is adjacent to the primary location, is addressed starting at 0fffefff0h, as shown in FIG. 3. The size of the primary and secondary locations as well as the address from which they are accessed are illustrative and should in no way be construed as limiting.

Initially, according to one embodiment, the processor 10 executes from the higher address, e.g. 0fffffff0h (Step 1). At this point, the new boot block 36 is retrieved from the non-volatile storage 38 and stored in the secondary location 24 (Step 2). The execution address remains pointed at the primary location 22.

In one embodiment, the new boot block 36, now in the secondary location 24, may be executed simply by changing the execution address. The address conversion 30 toggles a bit such that the processor 10 executes from the secondary location address, e.g. 0fffefff0h (Step 3). Notice that the location of the boot block 60 has not changed at all.

With the execution address still pointing at the secondary location 24, the new boot block 36 is copied from the secondary location 24 to the primary location 22 (Step 4). Because the processor 10 is now executing from the secondary location 24, the old boot block 60 is no longer needed. The new boot block 36 thus replaces the old boot block 60.

In one embodiment, before proceeding further, a confirmation is made that the new boot block 36 was successfully copied to the primary location 22 (Step 5). Notice that the new boot block 36 is now located in both the primary location 22 and the secondary location 24. Notice also that the execution address remains pointed to the secondary location 24.

Once assurance that the new boot block 36 was successfully copied to the primary location 22, the execution address is changed back to point to the primary location 22 (Step 6). The address conversion 30 changes the address from which the processor 10 executes instructions. In the embodiment of FIG. 3, the execution address may be changed by simply toggling a single address bit, A16. Note that the new boot block 36 is now located in the primary location 22. The secondary location 24 also still has the new boot block 36. However, execution by the processor 10 does not take place from the secondary location 24. Thus, the contents of the secondary location 24 are irrelevant.

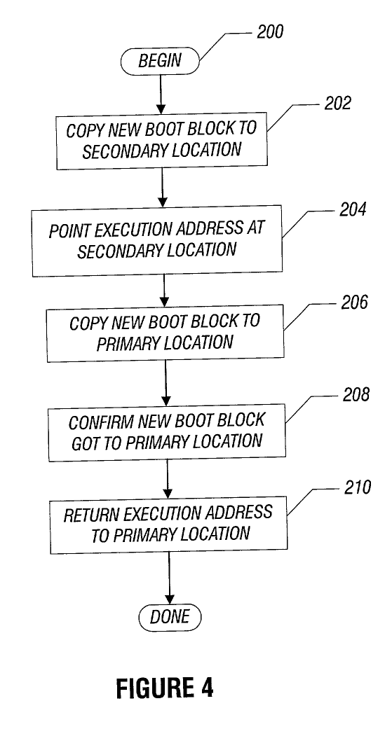

The software 200 may perform the operations of FIG. 3, as depicted in the flow diagram of FIG. 4. According to one embodiment, the new boot block 36 is first copied into the secondary location 24 (block 202). The execution address is then pointed to the secondary location 24, such as by toggling an address bit (block 204). This causes the new boot block 36 to be executed rather than the old boot block 60. If power is removed from the system 100, the system 100 continues to execute from the secondary location 24 until either the backup battery 34 or the jumper 32 are adjusted, in which case execution shall proceed from the primary location 22.

Next, the new boot block 36 is copied from the secondary location 24 to the primary location 22 (block 206). Before toggling the execution address back to the primary location 22, however, the software 200 confirms that the new boot block 36 got the primary location 22 in its entirety (block 208). Should the transfer of the new boot block 36 have been interrupted for some reason, the execution address continues to point to the new boot block 36 in the secondary location 24, so the system will still boot properly. Once the confirmation is complete, the execution address is modified to point back to the primary location 22 (block 210). In one embodiment, changing the execution address is achieved by toggling an address bit.

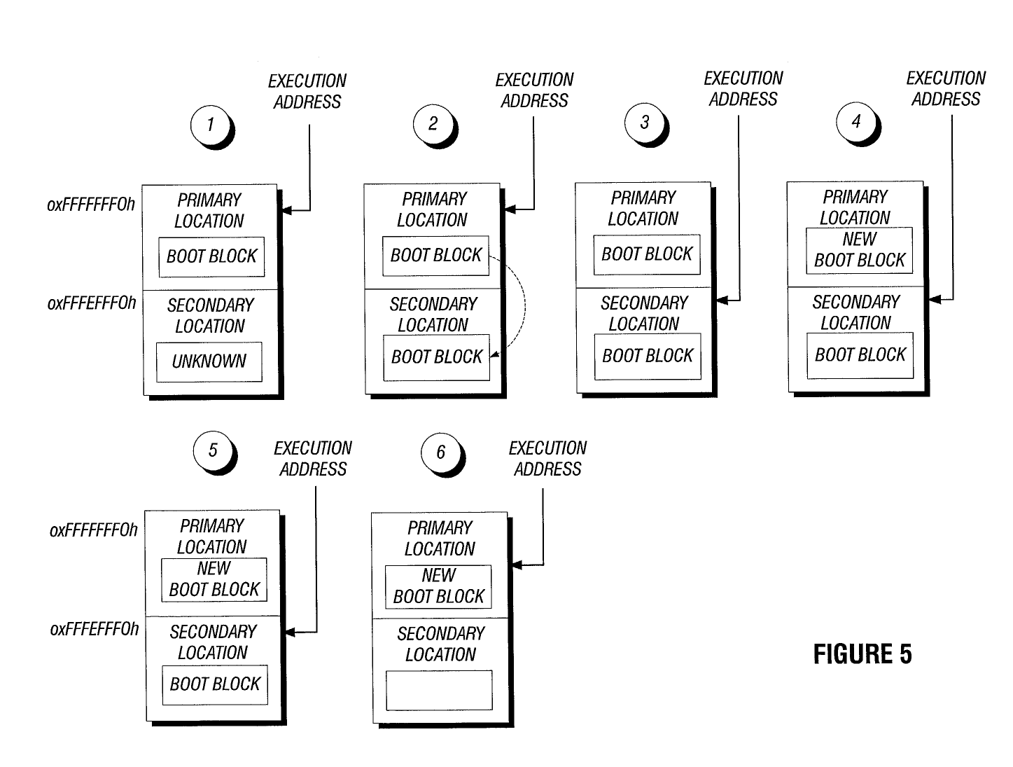

In FIG. 5, a block diagram illustrates operation of the system 100 to upgrade the boot block 60 according to a second embodiment. As in FIG. 3, each succeeding step or operation is specified by a numeral, 1 to 6. The primary location 22 and the secondary location 24 of the flash memory 20 are shown. As in FIG. 1, the boot block 60 occupies the primary location 22 and is addressed at 0fffffff0h. When the system 100 receives power, execution of the firmware 70 proceeds from this address. The secondary location 24, likewise, is addressed starting at 0fffefff0h.

First, according to one embodiment, the processor 10 executes from the 0fffffff0h address (Step 1). The contents of the secondary location 24 are at this time unknown. Then, rather than copying a new boot block from the memory 44, the boot block 26 is copied from the primary location 22 to the secondary location 24 (Step 2). The execution address remains pointed at the primary location 22.

Once the boot block 26 is stored in the secondary location 24, the execution address may be changed to point to the secondary location 24 (Step 3). The address conversion 30 toggles the bit such that the processor 10 executes from the secondary location execution address e.g., 0fffefff0h.

With the execution address still pointing at the secondary location, the new boot block 36 is copied from the non-volatile storage 38, first to the memory 44, then to the primary location 22. Alternatively, the new boot block 36 may be downloaded from across the network 40 to the system 100, in its memory 44. The new block 36 may then be copied to the primary location 22 (Step 4).

Once the new boot block 36 is completely copied to the primary location 22, the execution address may be changed back to point to the primary location 22. In one embodiment, however, a confirmation is made that the new boot block 36 was successfully copied to the primary location 22 (Step 5). In step 5, the execution address remains pointed to the secondary location 24.

Once assurance that the new boot block 36 was successfully copied to the primary location 22, the execution address is changed back to point to the primary location 22 (Step 6). The address conversion 30 changes the address to which the processor 10 will execute instructions. In the embodiment of FIG. 5, as in FIG. 3, the execution address may be changed by simply toggling a single address bit, A16. Note that the new boot block 36 is now located in the primary location 22. The contents of the secondary location 24 are irrelevant.

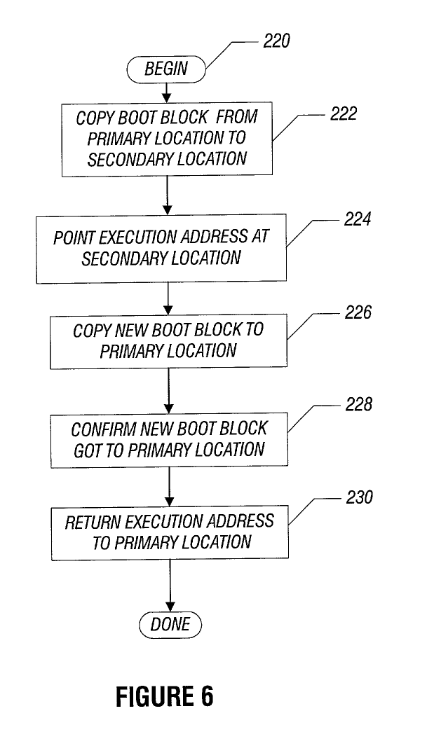

The software 200 may perform the operations of FIG. 5, as depicted in the flow diagram of FIG. 6. According to one embodiment, the boot block 26 is copied from the primary location 22 into the secondary location 24 (block 222). The execution address is then modified such that it points to the secondary location 24 (block 224). In one embodiment, the address conversion 30 of the system 100 changes the execution address. Address conversion causes the boot block 26 to be executed from the secondary location 24 rather than from the primary location 22. If power is removed from the system 100, the system 100 may continue to execute from the secondary location 24 until either the backup battery 34 or the jumper 32 is adjusted.

Next, the new boot block 36 is copied to the primary location (block 226). The new boot block 36 may be loaded into the memory 44 prior to this step, then copied to the primary location 22. In one embodiment, the software 200 confirms that the new boot block 36 got to the primary location 22 in its entirety prior to changing the execution address (block 228). Where transfer of the new boot block 36 failed or was otherwise interrupted, the execution address remains pointing to the secondary location 24. This ensures that the system still boots properly. Once the confirmation is complete, the execution address is modified to point back to the primary location 22 (block 230).

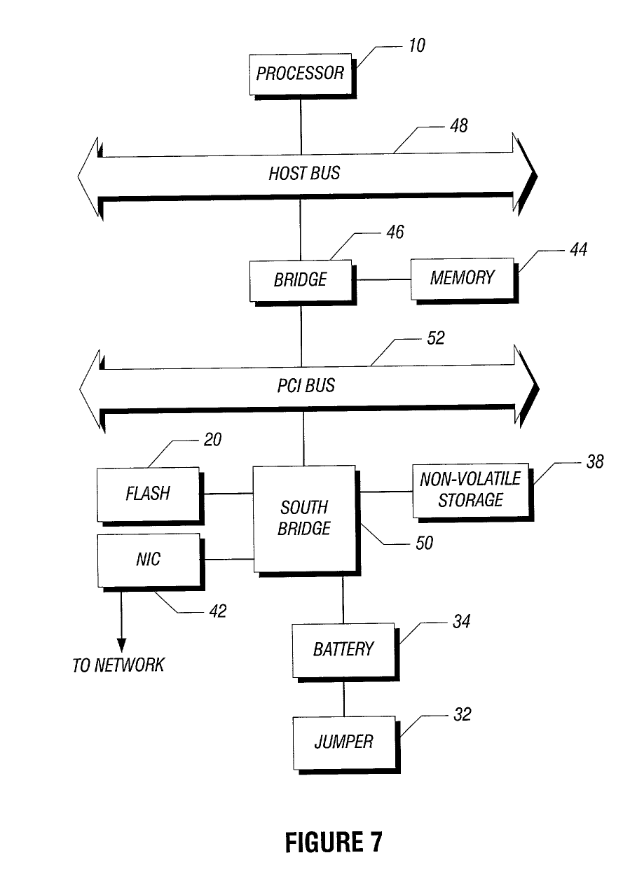

In one embodiment, the system 100 is part of a processor-based system, as depicted in FIG. 7. The processor 10 is coupled to a host bus 48, which connects the processor to the rest of the system 100. A bridge 46 is coupled between the host bus 48 and a PCI bus 52, according to one embodiment. The memory 44 is connected to the bridge 46.

In one embodiment, the system also includes a south bridge 50. The south bridge is a multi-function bridge, which supports the flash 20, the network interface card 42, and the non-volatile storage 38, as well as the battery 34 and jumper 32.

The above operations may be implemented where distinct devices share a single address. In some systems, multiple devices may each be addressed by the same address. The system typically includes a device select or other logic mechanism for deciding which of the multiple devices is to be accessed when the processor executes from the shared address.

In such systems, rather than move the execution address as done by the address conversion 30, described above, the device select or other logic mechanism may be adjusted. While no address conversion takes place in such systems, the principal of moving where the processor executes remains. Other mechanisms for alternately selecting devices may likewise be exploited in implementing a firmware, device driver, or other software upgrade.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a boot block into a secondary location;
pointing an execution address to the secondary location, wherein the execution address is the address from which a processor executes instructions when a system is turned on;
copying the boot block from the secondary location to a primary location; and
pointing the execution address to the primary location.

2. The method of claim 1, pointing an execution address to the secondary location further comprising:
inverting an address bit of the execution address.

3. The method of claim 2, inverting an address bit of the execution address further comprising inverting address bit sixteen of the execution address.

4. The method of claim 1, further comprising:
confirming that the copying of the boot block is complete prior to pointing the execution address to the primary location.

5. The method of claim 1, pointing the execution address to the primary location further comprising de-inverting the address bit of the execution address.

6. A system comprising:
a processor;
a flash memory comprising a primary location and a secondary location; and
a boot block executed from the primary location, wherein the boot block further:
receives a second boot block into the secondary location;
points an execution address to the secondary location;
copies the second boot block to the primary location; and
points the execution address to the primary location.

7. The system of claim 6, further comprising:
an address conversion mechanism for moving the execution address.

8. The system of claim 6, further comprising:
a non-volatile storage for storing the second boot block.

9. The system of claim 6, further comprising:
a network interface card for connecting a system to a network and for downloading the second boot block to the system.

10. The system of claim 6, further comprising:
a backup battery for maintaining the state of an address bit following a power cycle.

11. The system of claim 10, further comprising:
a jumper for adjusting the address bit if the backup battery fails.

12. An article comprising a medium storing instructions for enabling a processor-based system to:
receive a new boot block into a secondary location;
point an execution address to the secondary location, wherein the execution address is the address from which a processor executes instructions when the processor-based system is turned on;
copy the new boot block from the secondary location to a primary location; and
point the execution address to the first location.

13. The article of claim 12, further storing instructions for enabling a processor-based system to:
invert an address bit of the execution address.

14. The article of claim 13, further storing instructions for enabling the processor-based system:
invert address bit sixteen of the execution address.

15. The article of claim 12, further storing instructions for enabling a processor-based system to:
confirm that the copying of the new boot block is complete prior to pointing the execution address to the primary location.

16. The article of claim 12, further storing instructions for enabling a processor-based system to:
de-invert the address bit of the execution address.

17. A method comprising:
copying a boot block from a primary location to a secondary location;
pointing an execution address to the secondary location, wherein the execution address is the address from which a processor executes instructions when a system is turned on;
copying a new boot block to the primary location; and
pointing the execution address to the primary location.

18. The method of claim 17, pointing an execution address to the secondary location further comprising inverting an address bit of the execution address.

19. The method of claim 17, further comprising:
confirming that the copying of the boot block is complete prior to pointing the execution address to the primary location.

20. A system comprising:
a processor;
a flash memory comprising a primary location and a secondary location; and
a boot block executed from the primary location, wherein the boot further:
is copied to the secondary location;
points an execution address to the secondary location;
copies a new boot block to the primary location; and
points the execution address to the primary location.

21. The system of claim 20, further comprising:
an address conversion mechanism for moving the execution address.

22. The system of claim 21, further comprising:
backup battery for maintaining the state of an address bit following a power cycle.

23. The system of claim 20, further comprising:
a jumper for adjusting the address bit if the backup battery fails.

24. An article comprising a medium storing instructions for enabling a processor-based system to:
copy a boot block from a primary location to a secondary location;
point an execution address to the secondary location, wherein the execution address is the address from which a processor executes instructions when a system is turned on;
copy a new boot block to the primary location; and
point the execution address to the primary location.

25. The article of claim 24, further storing instructions for enabling a processor-based system to:
confirm that the copying of the boot block is complete prior to pointing the execution address to the primary location.

26. A method comprising:
receiving an upgrade program into a secondary location;
executing instructions from the secondary location by a processor;
copying the upgrade program from the secondary location to a primary location; and
executing instructions from the primary location.

27. The method of claim 26, further comprising:
modifying a logic component such that an execution address is pointed to the secondary location.

28. The method of claim 26, further comprising:
modifying an address bit such that an execution address is pointed to the secondary location.
